(19) United States
(12) Patent Application Publication
(10) Pub. No.: US 2008/0248395 A1
(43) Pub. Date: Oct. 9, 2008

(54) Electrolyte-Electrode Joined Assembly and Method for Producing the Same

(75) Inventors: Ushio Harada, Fujimino-shi (JP); Takayuki Yamada, Wako-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/098,195

(22) Filed: Apr. 4, 2008

(30) Foreign Application Priority Data
Apr. 6, 2007 (JP) 2007-100576

(51) Int. Cl. H01M 4/04; H01M 4/40; H01M 6/18

(52) U.S. Cl. 429/304; 429/209; 427/126.3

(57) ABSTRACT

A solid electrolyte is formed, and then a paste for forming an intermediate layer is applied thereto by printing, etc. The paste contains a mixed powder of a ceria-based oxide powder and a sintering aid powder containing at least one of Al, Ca, Co, Cr, Cu, Fe, Mn, Ni, and Zn, preferably a nitrate salt thereof. It is preferred that the sintering aid content is 0.5 to 5 mol %, and the ratio of the mixed powder to the paste is 40% to 80% by weight. The paste is burned preferably at 800° C. to 1500° C., more preferably 1100° C. to 1350° C., to form the intermediate layer having a thickness of 0.5 to 3 μm.

### BACKGROUND OF THE INVENTION

1. Field of the Invention

The present invention relates to an electrolyte-electrode joined assembly containing an anode and a cathode with a solid electrolyte interposed therebetween, and a method for producing the same.

2. Description of the Related Art

Solid oxide fuel cells (SOFCs), which have an electrolyte-electrode joined assembly formed by interposing a solid electrolyte between an anode and a cathode, are known as one type of fuel cells. In the electrolyte-electrode joined assembly for the SOFCs, the anode, solid electrolyte, and cathode are composed of, for example, a cermet of Ni and an yttria-stabilized zirconia (YSZ), a stabilized zirconia added with 10 mol % of Sc, and an La—Sr—Co—Fe—O-based perovskite-type oxide (LSCF), respectively.

For example, the electrolyte-electrode joined assembly having such a structure may be produced by the steps of sintering a powder to form the solid electrolyte, forming the cermet layer (anode) and the LSCF layer (cathode) on the surfaces of the solid electrolyte respectively, and burning the entire electrolyte-electrode joined assembly. The burning step is carried out at a high temperature, at which the cermet layer can be fused onto the solid electrolyte.

However, at the high temperature, the LSCF is activated, so that La or Sr is diffused into the solid electrolyte to generate high-resistant lanthanum zirconate or strontium zirconate. In this case, the internal resistance of the electrolyte-electrode joined assembly is increased, whereby the electrical properties of the SOFC are deteriorated. Thus, an intermediate layer is interposed between the solid electrolyte and the cathode to prevent the interaction therebetween. The intermediate layer has a function of accelerating oxygen ion diffusion from the cathode to the anode. Such an intermediate layer may be formed also between the solid electrolyte and the anode if necessary. CeO₂ added with Gd or Sm, i.e. a ceria-based oxide, is generally used as a material for the intermediate layer (see Japanese Laid-Open Patent Publication No. 2006-236844, etc.)

The intermediate layer needs to be dense to achieve the above functions. Because the ceria-based oxide is a sintering-resistant substance, it is expected that the ceria-based oxide have to be sintered at a relatively high temperature to form such a dense intermediate layer. However, when the sintering temperature is higher than 1600° C., the ceria-based oxide undergoes an interfacial reaction with an electrolyte or the like to form a compound layer. On the other hand, when the sintering temperature is excessively low in view of preventing the reaction, the resultant ceria-based oxide layer is not dense but porous, so that the interfacial resistance is increased, or the oxygen ion conduction is inhibited.

The intermediate layer may be formed by a pulsed laser ablation (PLD) method, a sputtering method, or the like. However, the methods for forming the layer disadvantageously require a long time and expensive equipment.

Alternatively, the intermediate layer may be formed by adding a sintering aid to the ceria-based oxide, and by sintering the mixture, as proposed in Andreas Mai, et al., “Ferrite-based perovskites as cathode materials for anode-supported solid oxide fuel cells Part II. Influence of the CGO interlayer”, Solid State Ionics, United States, 2006, Vol. 177, p. 2103-2107.

However, when the sintering aid is added to the ceria-based oxide, the stabilized zirconia (the solid electrolyte) is densified first, and the ceria-based oxide is greatly shrunk on the zirconia. As a result, a stress is generated between the ceria-based oxide and the stabilized zirconia, and the ceria-based oxide is peeled from the solid electrolyte or cracked due to the stress. Thus, when the sintering aid is added to the ceria-based oxide, it is difficult to prevent the peeling and cracking.

### SUMMARY OF THE INVENTION

A general object of the present invention is to provide an electrolyte-electrode joined assembly having an intermediate layer densified at a low temperature.

A principal object of the present invention is to provide an electrolyte-electrode joined assembly having an intermediate layer that is not peeled from a solid electrolyte.

Another object of the present invention is to provide an electrolyte-electrode joined assembly having an intermediate layer that is not cracked.

A further object of the present invention is to provide a method for producing the electrolyte-electrode joined assemblies having the intermediate layer.

According to an aspect of the present invention, there is provided an electrolyte-electrode joined assembly comprising an anode and a cathode with a solid electrolyte interposed therebetween, wherein an intermediate layer comprising a sintered body containing a ceria-based oxide is disposed between the solid electrolyte and at least one of the anode and the cathode, and the intermediate layer further contains at least one selected from the group consisting of Al, Ca, Co, Cr, Cu, Fe, Mn, Ni, and Zn derived from a sintering aid in a total amount of 0.5 to 5 mol %, and has a thickness of 0.5 to 3 μm and a relative density of 70% to 100%.

The intermediate layer is densified at a low temperature in the presence of the sintering aid. Thus, for example, formation of a compound layer due to an interfacial reaction between the intermediate layer and the solid electrolyte is reduced, whereby the resistance of the electrolyte-electrode joined assembly is not increased by the compound layer. By using the dense intermediate layer, the interfacial resistance between the intermediate layer and the electrode or solid electrolyte is prevented from being increased.

Since the intermediate layer has a thickness of 0.5 to 3 μm, it can be evenly densified. Thus, the intermediate layer can be prevented from being peeled from the solid electrolyte or being cracked.

Since the sintering aid content is 0.5 to 5 mol %, the conductivity is not reduced excessively.

For the reasons, electrical properties of an SOFC can be improved by using the electrolyte-electrode joined assembly.

The relative density can be obtained by dividing the actual density of the burned intermediate layer by the theoretical density of the intermediate layer, and by multiplying by 100. In the present invention, the theoretical density of the intermediate layer is calculated considering the sintering aid content. For example, when 2 mol % of the sintering aid is added to form the intermediate layer, the theoretical density of the intermediate layer is obtained using the following equation (1).

Theoretical density of intermediate layer=Theoretical density of sintering aid×0.02+Theoretical density of intermediate layer material×0.98 (1)

When the sintering aid is not an oxide, the theoretical density is calculated using the equation (1) assuming that the sintering aid is converted to an oxide. Specifically, even when the sintering aid is an iron nitrate salt, the theoretical density of iron oxide is used in the equation (1). For example, the theoretical density of a ceria (CeO₂) doped with Sm is 7.14 g/cm³. In contrast, in the case of adding thereto 2 mol % of Fe₂O₃, Al₂O₃, CoO, or CaO as the sintering aid, the theoretical density of the intermediate layer is 7.12 g/cm³, 7.11 g/cm³, 7.13 g/cm³, or 7.06 g/cm³, respectively.

Preferred examples of materials for the solid electrolyte include zirconia-based oxides and lanthanum gallate-based oxides. Thus, the electrolyte-electrode joined assembly of the present invention can be widely used in SOFCs.

According to another aspect of the present invention, there is provided a method for producing an electrolyte electrode joined assembly comprising an anode and a cathode with a solid electrolyte interposed therebetween, comprising the steps of: forming the solid electrolyte; applying, to at least one surface of the solid electrolyte, a paste comprising a powder of a ceria-based oxide and 0.5 to 5 mol % of a powder of a sintering aid containing at least one selected from the group consisting of Al, Ca, CO, Cr, Cu, Fe, Mn, Ni, and Zn; burning the applied paste to form an intermediate layer having a thickness of 0.5 to 3 μm and a relative density of 70% to 100%; forming the anode and the cathode directly on a surface of the solid electrolyte or on the intermediate layer respectively to form an assembly; and burning the assembly to produce the electrolyte-electrode joined assembly.

In this method, an electrolyte-supported-type, electrolyte-electrode joined assembly is obtained.

An anode-supported-type, electrolyte-electrode joined assembly may be produced. Thus, according to a further aspect of the present invention, there is provided a method for producing an electrolyte-electrode joined assembly comprising an anode and a cathode with a solid electrolyte interposed therebetween, comprising the steps of: forming an electrode substrate comprising one of the anode and the cathode; forming the solid electrolyte on one surface of the electrode substrate; burning the electrode substrate and the solid electrolyte; applying, to one surface of the solid electrolyte, a paste comprising a powder of a ceria-based oxide and 0.5 to 5 mol % of a powder of a sintering aid containing at least one selected from the group consisting of Al, Ca, Co, Cr, Cu, Fe, Mn, Ni, and Zn; burning the applied paste to form an intermediate layer having a thickness of 0.5 to 3 μm and a relative density of 70% to 100%; forming the other of the anode and the cathode on the intermediate layer to form an assembly; and burning the assembly to produce the electrolyte-electrode joined assembly.

In this method, another intermediate layer, other than the above intermediate layer, may be formed on the one surface of the electrode substrate, and then the solid electrolyte, the above intermediate layer, and the other of the anode and the cathode may be formed thereon, to produce an electrolyte-electrode joined assembly having the intermediate layers formed between the anode and the solid electrolyte and between the cathode and the solid electrolyte respectively.

In the present invention, as compared with conventional methods, the intermediate layer can be densified at a lower temperature by adding the sintering aid as described above. For example, the paste may be burned at a temperature of 800° C. to 1500° C.

In other words, a substantially uniformly densified, intermediate layer can be formed at a relatively low temperature in the present invention. Thus, the intermediate layer can be prevented from being peeled off from the solid electrolyte or being cracked, and the formation of a compound layer can be prevented between the intermediate layer and the solid electrolyte, so that an electrolyte-electrode joined assembly excellent in conductivity, and a fuel cell excellent in electrical properties can be produced.

The powder of the ceria-based oxide preferably has a specific surface area of 3 to 15 m²/g. In this case, the densification is further accelerated.

For example, the weight ratio of the powders of the ceria-based oxide and the sintering aid to the paste may be 40% to 80% by weight, and the paste may be applied by screen printing to form the intermediate layer. The intermediate layer having a remarkably small thickness of 0.5 to 3 μm can be formed with excellent dimensional accuracy in this manner.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic, overall, explanatory cross sectional view of an electrolyte-electrode joined assembly (MEA) according to an embodiment of the present invention;

FIG. 2 is a schematic, overall, explanatory cross-sectional view of an electrolyte-electrode joined assembly (MEA) according to another embodiment;

FIG. 3 is a graph showing relations between burning temperature and relative density of Examples 1 to 4 and Comparative Example;

FIG. 4 is a graph showing relations between burning temperature and conductivity of Examples 1 to 4 and Comparative Example;

FIG. 5 is a graph showing relations between temperature and conductivity of electrolyte-electrode joined assemblies (MEAs) according to the embodiment; and

FIG. 6 is a graph showing relations between current density and voltage of electrolyte-electrode joined assemblies (MEAs) according to the embodiment.

### DESCRIPTION OF THE PREFERRED EMBODIMENTS

A preferred embodiment of the electrolyte-electrode joined assembly and the producing method of the present invention will be described in detail below with reference to accompanying drawings.

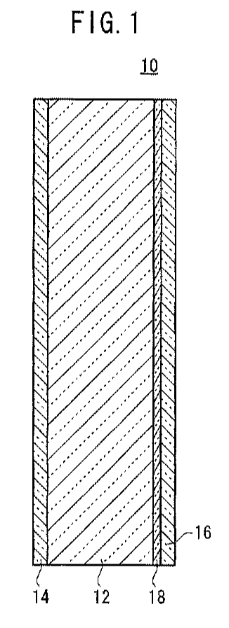

FIG. 1 is a schematic, overall, explanatory cross-sectional view showing an electrolyte-electrode joined assembly (which may be hereinafter referred to as an MEA) 10 according to the embodiment. The MEA 10 is such an electrolyte-supported-type assembly that a solid electrolyte 12 is sandwiched between an anode 14 and a cathode 16, and the solid electrolyte 12 is thicker than the anode 14 and the cathode 16. An intermediate layer 18 is interposed between the solid electrolyte 12 and the cathode 16.

In this embodiment, the anode 14 is composed of a cermet of Ni and yttria-stabilized zirconia (YSZ) and has a thickness of about 5 μM, and the solid electrolyte 12 is composed of a stabilized zirconia added with 10 mol % of Sc (10SSZ) and has a thickness of about 200 μm. The 10SSZ acts as an oxygen ion conductor.

The intermediate layer 18, interposed between the solid electrolyte 12 and the cathode 16, acts as a diffusion-preventing layer for inhibiting an element diffusion in the direction from the solid electrolyte 12 to the cathode 16 or the reverse direction. The intermediate layer 18 comprises a sintered body of a ceria-based oxide represented by the composition formula Of Ce₁₋ₐXₐO₂ (0≦a<1). In the formula, X represents an element replacing a Ce site of CeO₂, and is preferably Sm, Gd, or the like.

The intermediate layer 18 further contains at least one element selected from the group consisting of Al, Ca, Co, Cr, Cu, Fe, Mn, Ni, and Zn derived from a sintering aid to be hereinafter described. These elements may form a composite oxide together with the ceria-based oxide, and may be in the reduced state of the sintering aid, in the intermediate layer 18.

The intermediate layer 18 is densified in the presence of the sintering aid at a relatively low temperature as described below. Thus, formation of a compound layer is prevented between the intermediate layer 18 and the solid electrolyte 12.

The content of the at least one element is 0.5 to 5 mol %. When the intermediate layer 18 contains a plurality of the elements, the total content thereof is 0.5 to 5 mol %. When the content is less than 0.5 mol %, the sintering aid shows a poor effect for accelerating the sintering of the ceria-based oxide at a relatively low temperature. On the other hand, when the content is more than 5 mol %, the content of the ceria-based oxide is made relatively low in the intermediate layer 18, the oxygen ion conductivity is often reduced.

As described above, the intermediate layer 18 has a dense structure. Specifically, the intermediate layer 18 has a relative density of 70% to 100%. As shown in the above equation (1), the relative density of the intermediate layer 18 is obtained from the theoretical density calculated considering the content of the sintering aid added to the intermediate layer 18.

The intermediate layer 18 has a thickness of 0.5 to 3 μm. When the thickness is less than 0.5 μm, the intermediate layer 18 shows a poor function of preventing the element diffusion. Further, the intermediate layer 18 is likely to have thickness unevenness, and the cathode 16 may be partly in direct contact with the solid electrolyte 12 without the intermediate layer 18. On the other hand, when the thickness is more than 3 μm, the intermediate layer 18 tends to be peeled off from the solid electrolyte 12 or cracked easily. In other words, by controlling the thickness within the above range, the intermediate layer 18 can be strongly bonded to the solid electrolyte 12 without cracking. The thickness of the intermediate layer 18 is more preferably 1 to 2 μm.

The cathode 16 is stacked on thus obtained intermediate layer 18 to form the MEA 10. The cathode 16 is composed of an La—Sr—Co—Fe—O-based perovskite-type oxide (LSCF) and has a thickness of about 5 μm.

The MEA 10 according to this embodiment basically has the above structure. The advantageous effects thereof will be described below.

The MEA 10 having the above structure is sandwiched between a pair of separators to form a unit cell. A plurality of the unit cells are stacked to produce an SOFC. The SOFC is driven such that, after heating the SOFC to a predetermined temperature, a fuel gas containing hydrogen is supplied to the anode 14 of each unit cell, and an oxidant gas containing oxygen is supplied to the cathode 16. The oxygen is ionized on the cathode 16, and the generated oxygen ions are transferred through the intermediate layer 18 and the solid electrolyte 12 to the anode 14.

In this process, the oxygen ions can be readily transferred since the intermediate layer 18 has a dense structure without cracking and is strongly bonded to the solid electrolyte 12 and the cathode 16. An element such as La is not diffused from the cathode 16 to the solid electrolyte 12 since the diffusion is prevented by the intermediate layer 18 as described above. Further, the solid electrolyte 12 can be prevented from being poisoned due to diffusion of Cr, etc. from the separator.

For the above reasons, deterioration of the electrical properties of the SOFC can be prevented. Thus, the MFA 10 having the intermediate layer 18 according to this embodiment does not deteriorate the electrical properties of the SOFC.

The MEA 10 can be produced in the following manner.

First, the solid electrolyte 12 is formed. A powder of the 10SSZ is shaped together with a binder into a compact. The thickness of the compact is controlled such that the thickness of the solid electrolyte 12 is about 200 μm after a burning treatment. The compact is subjected to a degreasing treatment and the burning treatment, to form the solid electrolyte 12.

Then, a paste for forming the intermediate layer 18 is screen-printed onto at least one surface of the solid electrolyte 12.

The paste contains a mixed powder of a ceria-based oxide powder and a sintering aid powder. The ceria-based oxide powder preferably has a specific surface area of 3 to 15 m²/g. In this case, densification is further accelerated in the burning treatment to be hereinafter described.

The sintering aid contains at least one element selected from the group consisting of Al, Ca, Co, Cr, Cu, Fe, Mn, Ni, and Zn, and preferably contains a nitrate salt of the element, such as Al(NO₃)₃, Ca(NO₃)₂, Co(NO₃)₂, or Fe(NO₃)₃. The ratio of the sintering aid to the mixed powder is 0.5 to 5 mol %. When the ratio is less than 0.5 mol %, the ceria-based oxide powder cannot be sufficiently sintered by the sintering aid, and it is difficult to densify the intermediate layer 18. On the other hand, when the ratio is more than 5 mol %, the amount of residues derived from the sintering aid is increased, and the conductivity of the intermediate layer 16 is deteriorated.

The paste may contain a binder, a dispersant, and a plasticizer, if necessary. An ethylcellulose, polyvinyl butyral, or the like can be preferably used as the binder, and an ester-based, nonionic active agent can be used as the dispersant. Preferred examples of the plasticizer include dibutyl phthalate.

The paste may be prepared by adding the mixed powder, binder, dispersant, and plasticizer to an appropriate solvent such as terpineol, and by pulverizing and mixing the components using a ball mill. The weight ratio of the mixed powder to the paste is 40% to 80% by weight. By controlling the weight ratio within this range, the powder can be densely printed to form the intermediate layer 18, the interparticle distance being shortened. Thus, the dense intermediate layer 18 can be formed. In other words, the sintering properties of the intermediate layer 18 can be improved. Further, pore formation on the intermediate layer 18 can be prevented.

Furthermore, the mixed powder can be near the closest packing state, so that the shrinkage of the paste, i.e., the volume change of the intermediate layer 18, due to the burning treatment can be reduced. Therefore, the intermediate layer 18 can be prevented from being peeled off from the solid electrolyte 12 in the burning treatment.

In the screen printing, the printing thickness of the paste is controlled such that the intermediate layer 18 has a thickness of 0.5 to 3 μm after the burning treatment.

Then, the paste is subjected to the burning treatment. Since the paste contains the sintering aid for accelerating the densification of the ceria-based oxide, the paste may be burned at a low burning temperature of 800° C. to 1500° C. The burning temperature is more preferably 1000° C. to 1350° C. In the case of using the nitrate salt as the sintering aid, the nitrate salt is converted to an oxide such as Al₂O₃, CaO, COO, or Fe₂O₃ in the burning treatment.

When the ceria-based oxide powder has a specific surface area of 3 to 15 m²/g, the densification is further accelerated. When it is less than 3 m²/g, the densification hardly proceeds. When it is more than 15 m²/g, it is difficult to prepare the paste from the powder. The specific surface area can be obtained by BET.

As described above, in this embodiment, the ceria-based oxide (the intermediate layer 18) can be densified at a temperature lower than conventional burning temperatures, by 100° C. or more. Further, the final intermediate layer 18 has a remarkably small thickness of 0.5 to 3 μm, and thus can be prevented from being cracked or peeled off from the solid electrolyte 12 due to heat expansion coefficient difference.

The intermediate layer 18 densified in the above manner has a relative density of 70% or more, obtained using the above equation.

The anode 14 of the NI—YSZ is bonded onto the other surface of the solid electrolyte 12, on which the intermediate layer 18 is not formed, by burning, and the cathode 16 of the LSCF is bonded onto the intermediate layer 18 by burning. Thus, the MEA 10 shown in FIG. 1 is obtained.

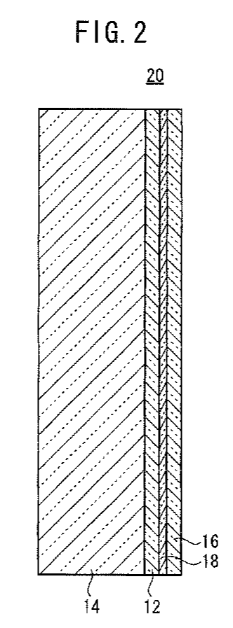

Also an anode-supported-type, electrolyte-electrode joined assembly (MEA) 20 shown in FIG. 2 can be produced in the present invention. In this case, an anode 14 may be formed first, and then a solid electrolyte 12, an intermediate layer 18, and a cathode 16 may be formed on the anode 14.

For example, a compact containing a mixed powder of NiO and YSZ is degreased and calcined, to prepare a calcined body having a thickness of 500 μm. A paste containing a 10SSZ powder is applied to the calcined body by screen printing, and the resultant is burned to densify the calcined body and applied paste, to form the anode 14 and the solid electrolyte 12.

Then, the intermediate layer 18 is formed in the above manner. The paste containing the mixed powder of the ceria-based oxide powder and the sintering aid powder is applied to the solid electrolyte 12 by screen printing, and is burned at 800° C. to 1500° C., more preferably 1000° C. to 1350° C. The ceria-based oxide is thus densified to form the intermediate layer 18 having a thickness of 0.5 to 3 μm.

The cathode 16 of LSCF is bonded onto the intermediate layer 18 by burning finally, to produce the MEA 20 shown in FIG. 2.

Though the intermediate layer 18 is interposed between the cathode 16 and the solid electrolyte 12 in this embodiment, it may be interposed between the anode 14 and the solid electrolyte 12. Of course, the intermediate layer 18 may be formed between the cathode 16 and the solid electrolyte 12, and between the anode 14 and the solid electrolyte 12, respectively.

In the case of forming the intermediate layer 18 between the anode 14 and the solid electrolyte 12 in the anode-supported-type MEA 20, the step of forming the intermediate layer 18 may be carried out after forming the anode 14 or the calcined body.

The material for the solid electrolyte 12 is not limited to the 10SSZ as long as it can act as an oxygen ion conductor. Preferred examples of such materials include lanthanum gallate-based oxides.

### Example 1

2 mol % of a cobalt nitrate salt powder was added to a powder of Ce_{0.8}Sm_{0.2}O₂ (which may be referred to as SDC) having a specific surface area of 5 m²/g. The powders were mixed and stirred for 24 hours by a ball mill using an alcohol as a solvent, and then dried to remove the alcohol.

The obtained mixed powder was preformed by a hand press, and subjected to hydrostatic molding (CIP), to prepare a cylindrical compact having a bottom diameter of approximately 6 mm. The compact was degreased if necessary, and maintained at 800° C. for 5 hours in a burning treatment. The shrinkage ratio of the compact was calculated, and the relative density was obtained by Archimedes method. Further, compacts were prepared and burned in the same manner except for changing the burning temperature to 900° C., 1000° C., 1100° C., 1200° C., 1300° C., 1400° C., or 1500° C., and the relative densities were obtained. As a result, it was confirmed that the compacts could be densified at the above burning temperatures. Also in the case of changing the Co content to 0.5, 1, 3, or 5 mol %, the densification could be observed at all the burning temperatures. When the Co content was 0.5 or 1 mol %, the densest sintered body was obtained by burning at 1400° C. or 1100° C. respectively.

Further, compacts were prepared and burned in the same manner as above except for using 2 mol % of a nitrate salt of calcium, iron, aluminum, copper, nickel, manganese, chromium, or zinc instead of the cobalt nitrate salt, respectively. As a result, dense sintered bodies were obtained by burning at the above temperatures. The densest sintered bodies were obtained by burning at 1100° C., 1200° C., 1400° C., 1300° C., 1300° C., 1300° C., 1300° C., and 1300° C. respectively.

It is clear from the results that the dense ceria-based oxide bodies can be prepared by using the sintering aids containing the above elements at the lower temperatures, as compared with conventional ones.

### Example 2

2 mol % of a cobalt nitrate salt powder was added to an SDC powder having a specific surface area of 5 m²/g. Compacts were prepared from the mixture and burned at 1000° C., 1100° C., 1200° C., 1300° C., 1400° C., or 1500° C. in the same manner as above, to obtain cylindrical sintered bodies of Sample 1 respectively. The relative densities of the sintered bodies were obtained by Archimedes method, and then the sintered bodies were cut into a height of 2 mm.

A platinum electrode and a platinum wire were bonded to each sintered body under burning, and the impedance was measured at 700° C. by an alternative 4-terminal method. The measurement was carried out using Impedance Analyzer SI1260/1287 manufactured by Solartron under conditions of a frequency of 0.1 Hz to 4 MHz and amplitude of 0.01 to 0.1 V. Further, the conductivity of each sintered body was obtained based on the measured impedance.

Sintered bodies of Samples 2 to 4 were obtained in the same manner as above except for using 2 mol % of an iron nitrate salt, 3 mol % of a calcium nitrate salt, or 2 mol % of an aluminum nitrate salt instead of the cobalt nitrate salt, respectively. The relative density and conductivity of each sintered body were obtained in the same manner as above.

For comparison, sintered bodies of Comparative Example were obtained in the same manner as above except that only the SDC powder having a specific surface area of 5 m²/g was sintered. The relative density and conductivity of each sintered body were obtained in the same manner.

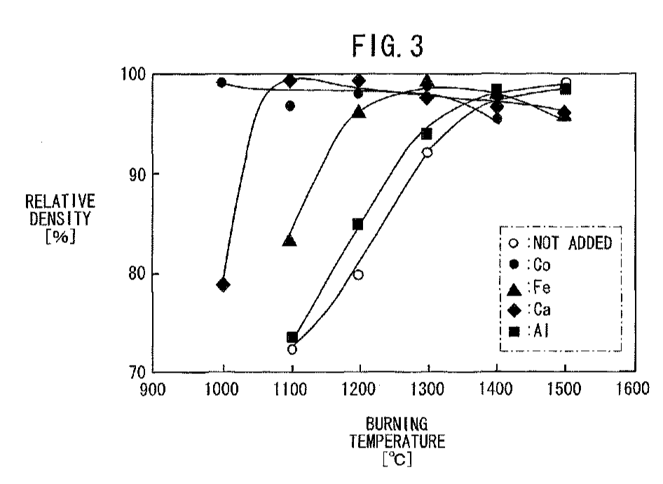

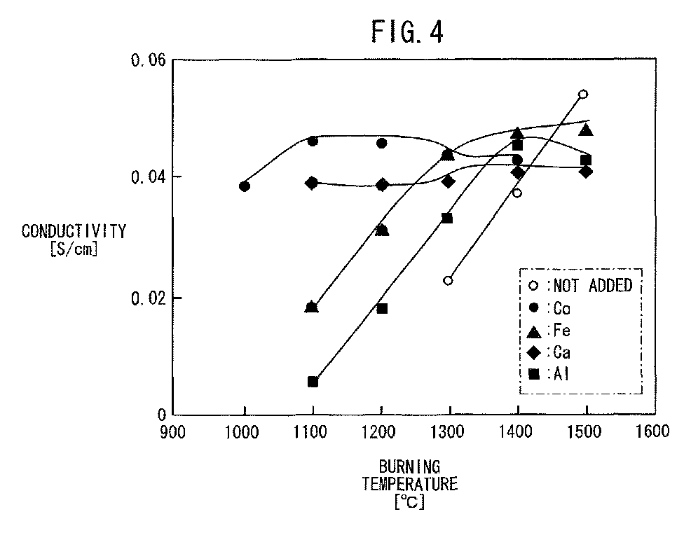

The relations between the burning temperature and the relative density of Examples 1 to 4 and Comparative Example are shown in FIG. 3, and the relations between the burning temperature and the conductivity thereof are shown in FIG. 4. It is clear from FIGS. 3 and 4 that the dense sintered bodies of the ceria-based oxide can be obtained with excellent conductivities at the low temperatures by adding the above sintering aids.

### Example 3

A 10SSZ solid electrolyte having a thickness of approximately 200 μm was formed. A paste containing 50% by weight of a mixed powder was screen-printed onto one surface of the solid electrolyte into various thicknesses, and burned at 1250° C. The mixed powder was composed of an SDC powder having a specific surface area of 5 m²/g, added with 2 mol % of a cobalt nitrate salt powder. SDC layers having a thickness of 0.5, 1, 2, 3, 4, 5, 7, 9, or 10 μm were formed in this manner respectively. The SDC layers having a thickness of 0.5 to 3 μm were bonded to the 10SSZ solid electrolyte without peeling, while the SDC layers having a thickness of 4 μm or more were peeled from the solid electrolyte.

SDC layers having a thickness of 2 μm were formed in the same manner as above except that the paste contained 50%, 60%, 70%, or 80% by weight of a mixed powder, and the mixed powder was composed of an SDC powder having a specific surface area of 10 m²/g, added with 2 mol % of a cobalt nitrate salt powder. It was confirmed that the SDC layers were bonded to the 10SSZ solid electrolyte without peeling.

### Example 4

A 10SSZ solid electrolyte having a thickness of approximately 200 μm was formed. A paste containing 50% by weight of a mixed powder was screen-printed onto one surface of the solid electrolyte, and burned at 1250° C. or 1350° C., to form an SDC intermediate layer having a thickness of 2 μm. The mixed powder was composed of an SDC powder having a specific surface area of 5 m²/g, added with 2 mol % of a cobalt nitrate salt powder. An LSCF cathode was formed on the intermediate layer, and an Ni—YSZ anode was formed on the other surface of the 10SSZ solid electrolyte, to produce an electrolyte-supported-type MEA shown in FIG. 1. A comparative electrolyte-supported-type MEA was produced in the same manner as above except that the cobalt nitrate salt powder was not used and the paste was burned at 1450° C.

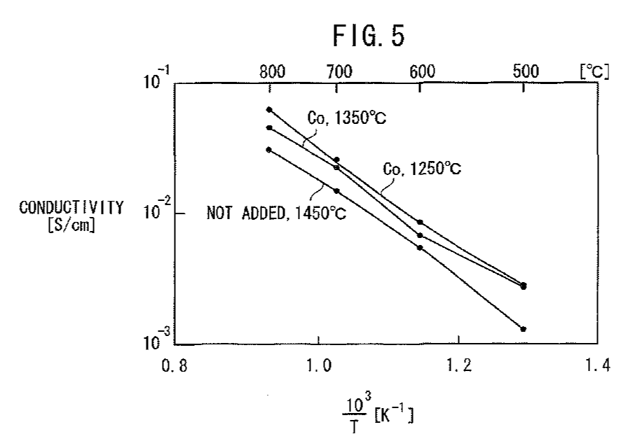

The conductivity of each MEA was measured at various temperatures. The results are shown in FIG. 5. It is clear from FIG. 5 that the MEA excellent in conductivity can be produced even at a relatively low burning temperature by adding the sintering aid of the cobalt nitrate salt.

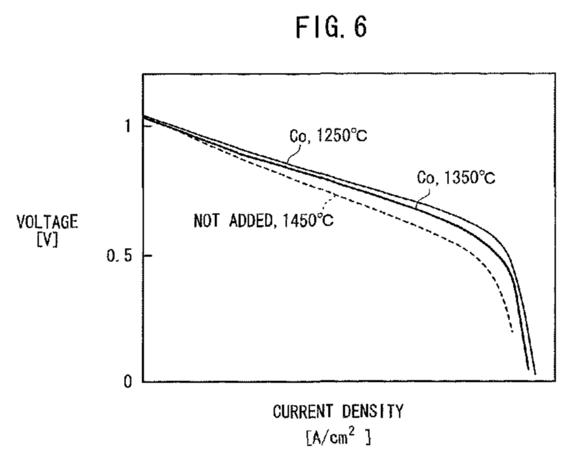

Further, the relation between current density and voltage of each MEA was examined. As shown in FIG. 6, the intermediate layer formed at a lower burning temperature showed a higher voltage even under a higher current density.

This seems because interfacial reactions between the solid electrolyte and the intermediate layer were prevented by using the lower burning temperature.

What is claimed is:

1. An electrolyte-electrode joined assembly comprising an anode and a cathode with a solid electrolyte interposed therebetween, wherein
an intermediate layer comprising a sintered body containing a ceria-based oxide represented by the composition formula of Ce₁₋ₐXₐO₂ (in which X is an element replacing a Ce site of CeO₂, and 0≦a<1) is disposed between said solid electrolyte and at least one of said anode and said cathode, and
said intermediate layer further contains at least one selected from the group consisting of Al, Ca, Co, Cr, Cu, Fe, Mn, Ni, and Zn derived from a sintering aid in a total amount of 0.5 to 5 mol %, and has a thickness of 0.5 to 3 μm and a relative density of 70% to 100%.

2. An electrolyte-electrode joined assembly according to claim 1, wherein said solid electrolyte comprises a zirconia-based oxide or a lanthanum gallate-based oxide.

3. An electrolyte-electrode joined assembly according to claim 1, wherein said element X in said ceria-based oxide is Sm or Gd.

4. A method for producing an electrolyte-electrode joined assembly comprising an anode and a cathode with a solid electrolyte interposed therebetween, comprising the steps of:
forming said solid electrolyte;
applying, to at least one surface of said solid electrolyte, a paste comprising a powder of a ceria-based oxide represented by the composition formula of Ce₁₋ₐXₐO₂ (in which X is an element replacing a Ce site of CeO₂, and 0≦a<1) and 0.5 to 5 mol % of a powder of a sintering aid containing at least one selected from the group consisting of Al, Ca, Co, Cr, Cu, Fe, Mn, Ni, and Zn;
burning the applied paste to form an intermediate layer having a thickness of 0.5 to 3 μm and a relative density of 70% to 100%;
forming said anode and said cathode directly on a surface of said solid electrolyte or on said intermediate layer, respectively, to form an assembly; and
burning said assembly to produce said electrolyte-electrode joined assembly.

5. A method according to claim 4, wherein said paste is burned at a temperature of 800° C. to 1500° C.

6. A method according to claim 4, wherein said powder of said ceria-based oxide has a specific surface area of 3 to 15 m²/g.

7. A method according to claim 4, wherein the weight ratio of said powders of said ceria-based oxide and said sintering aid to said paste to be formed into said intermediate layer is 40% to 80% by weight, and said paste is applied by screen printing.

8. A method according to claim 4, wherein said element X in said ceria-based oxide is Sm or Gd.

9. A method according to claim 4, wherein said sintering aid is a nitrate salt.

10. A method for producing an electrolyte-electrode joined assembly comprising an anode and a cathode with a solid electrolyte interposed therebetween, comprising the steps of:
forming an electrode substrate comprising one of said anode and said cathode;
forming said solid electrolyte on one surface of said electrode substrate;
burning said electrode substrate and said solid electrolyte;
applying, to one surface of said solid electrolyte, a paste comprising a powder of a ceria-based oxide represented by the composition formula of Ce₁₋ₐXₐO₂ (in which X is an element replacing a Ce site of CeO₂, and 0≦a<1) and 0.5 to 5 mol % of a powder of a sintering aid containing at least one selected from the group consisting of Al, Ca, Co, Cr, Cu, Fe, Mn, Ni, and Zn;
burning said applied paste to form an intermediate layer having a thickness of 0.5 to 3 μm and a relative density of 70% to 100%;
forming the other of said anode and said cathode on said intermediate layer to form an assembly; and
burning said assembly to produce said electrolyte-electrode joined assembly.

11. A method according to claim 10, wherein another intermediate layer is formed on said one surface of said electrode substrate, and then said solid electrolyte, said intermediate layer, and said other of said anode and said cathode are formed on said other intermediate layer.

12. A method according to claim 10, wherein said paste is burned at a temperature of 800° C. to 1500° C.

13. A method according to claim 10, wherein said powder of said ceria-based oxide has a specific surface area of 3 to 15 m²/g.

14. A method according to claim 10, wherein the weight ratio of said powders of said ceria-based oxide and said sintering aid to said paste to be formed into said intermediate layer is 40% to 80% by weight, and said paste is applied by screen printing.

15. A method according to claim 10, wherein said element X in said ceria-based oxide is Sm or Gd.

16. A method according to claim 10, wherein said sintering aid is a nitrate salt.
